(19) United States
(12) Patent Application Publication
(10) Pub. No.: US 2018/0051888 A1
(43) Pub. Date: Feb. 22, 2018

(54) OVEN APPLIANCE SURFACE ELEMENT WITH NO ONBOARD SENSOR

(71) Applicant: Haier US Appliance Solutions, Inc., Wilmington, DE (US)

(72) Inventor: Christopher Lee Hettinger, Louisville, KY (US)

(21) Appl. No.: 15/242,747

(22) Filed: Aug. 22, 2016

(51) Int. Cl. F24C 7/08; H05B 3/74

(52) U.S. Cl. CPC F24C 7/083; H05B 3/742

(57) ABSTRACT

An oven appliance and methods of operating the appliance, the appliance including a cooktop and one or more heating elements wherein the heating elements have no onboard sensors. The oven appliance also includes a resistance sensor for remotely sensing the resistance of the one or more heating elements to indirectly determine whether the cooktop is relatively cool before deactivating an associated hot surface indicator light.

### FIELD OF THE INVENTION

The present disclosure relates generally to oven appliances and methods for oven appliance operation. In particular, the present disclosure is directed to the use of resistance sensors in oven appliances, and methods which utilize such technology.

### BACKGROUND OF THE INVENTION

Oven appliances are frequently utilized in a variety of settings to cook food items. During operation of an oven appliance, relatively high temperatures can be generated, for example, in the cooking chamber or on the cooktop of the oven appliance. Further, heating elements of a cooktop can retain heat for some time after deactivation. As such, it is desired to provide an indication that the cooktop surface is relatively hot to inform users of the hot surface condition. For example, a hot surface indicator light can be used. The current approach is to determine if the cooktop surface is relatively hot by directly measuring the temperature of the heating element(s) thereon using onboard temperature sensors, i.e., sensors or a thermal switch mounted on the heating element(s).

The presence of such onboard temperature sensors necessarily increases the size of the cooktop relative to the total volume of the oven appliance. However, it is desired to provide a greater oven capacity, e.g., as measured by the cubic feet of volume provided inside the a cooking chamber of the oven. For a given size cabinet of the oven appliance, the possible volume of the cooking chamber therein is limited by, e.g., the amount of space within the cabinet taken up by the cooktop and associated sensors.

Accordingly, improved oven appliances and methods for operating oven appliances are desired. In particular, oven appliance and methods which provide a hot surface indication while increasing oven capacity would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, an oven appliance is provided. The oven appliance includes a cabinet defining a cooking chamber, the cooking chamber configured for receipt of items to be cooked and a cooktop disposed on the cabinet, the cooktop comprising at least one heating element. The oven appliance also includes an indicator light, a resistance sensor spaced from the heating element, and a controller in communication with the heating element, the resistance sensor, and the indicator light, the controller operable to store a cool resistance value of the heating element, to illuminate the indicator light when the heating element is turned on, to keep the indicator light illuminated after the heating element is turned off, to monitor the resistance of the heating element after it is turned off, and to turn off the indicator light when the resistance of the heating element equals the cool resistance value.

In accordance with another embodiment, a method for operating an oven appliance is provided. The method includes activating a heating element, illuminating an indicator light when the heating element is activated, deactivating the heating element, keeping the indicator light illuminated after the heating element is deactivated, monitoring resistance of the heating element after the heating element is deactivated, and turning off the indicator light when the resistance of the heating element equals a cool resistance value of the heating element.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an oven appliance according to an exemplary embodiment of the present subject matter.

FIG. 2 provides a section view of the oven appliance of FIG. 1 taken along the 2-2 line of FIG. 1.

FIG. 3 provides a perspective view of an exemplary embodiment of an oven appliance cooktop according to an exemplary embodiment of the present subject matter.

FIG. 4 provides a perspective view of another exemplary embodiment of an oven appliance cooktop according to another exemplary embodiment of the present subject matter.

FIG. 5 provides a flowchart of a method for operating an oven appliance according to an exemplary embodiment of the present subject matter.

FIG. 6 provides a flowchart of a method for operating an oven appliance according to an exemplary embodiment of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

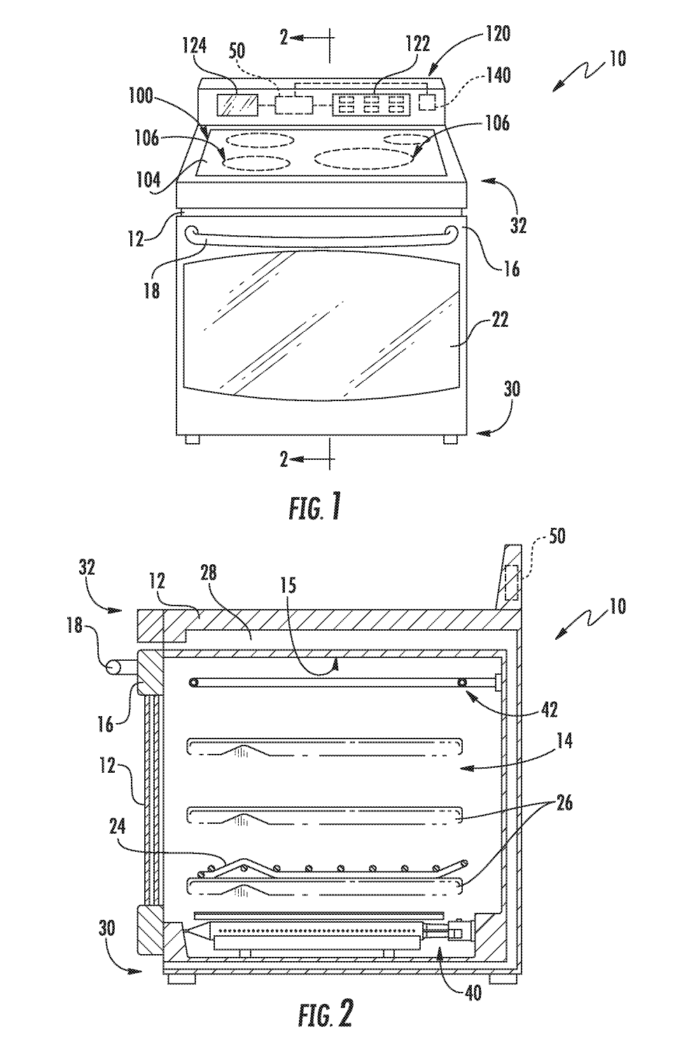

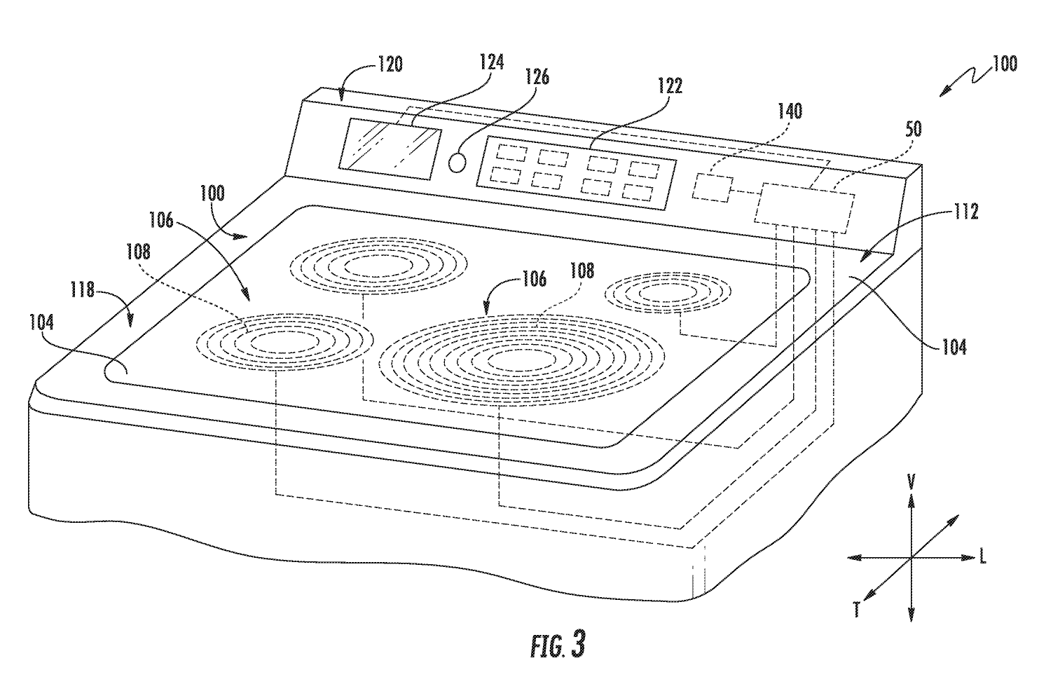

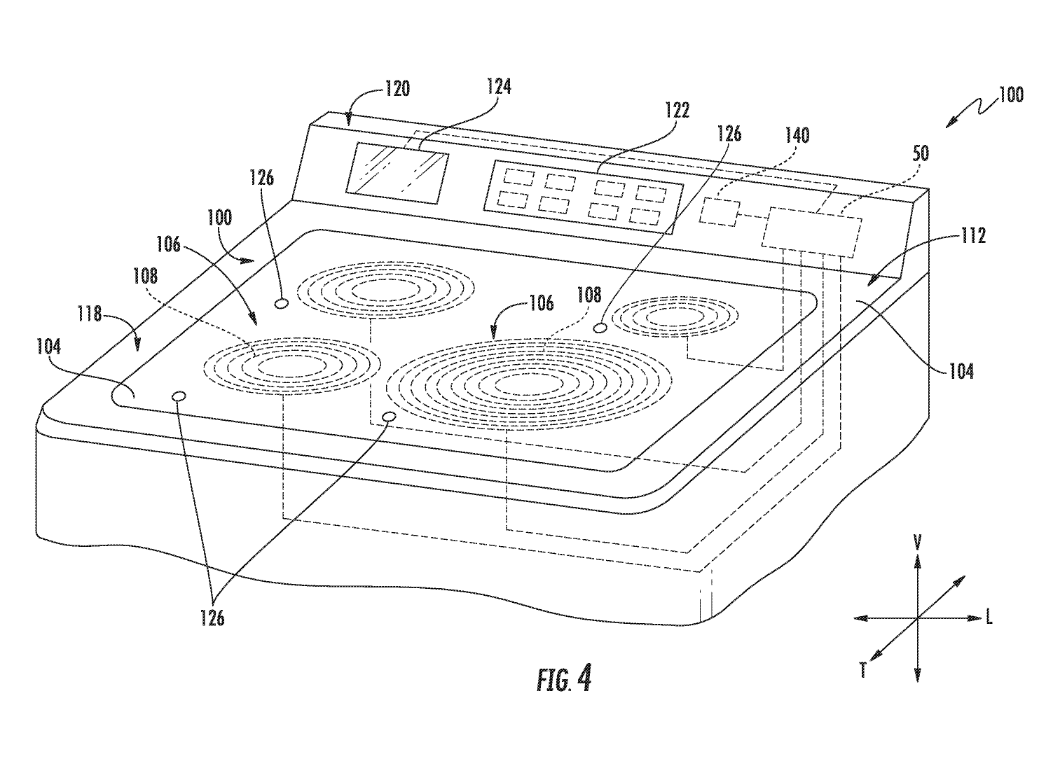

FIG. 1 provides a perspective view of an oven appliance 10 according to an exemplary embodiment of the present subject matter. FIG. 2 provides a section view of oven appliance 10 taken along the 2-2 line of FIG. 1. As may be seen, e.g., in FIGS. 3 and 4, oven appliance 10 defines a vertical direction V, a lateral direction L and a transverse direction T. The vertical direction V, the lateral direction L and the transverse direction T are mutually perpendicular and form an orthogonal direction system. Oven appliance 10 is provided by way of example only and is not intended to limit the present subject matter in any aspect. Thus, the present subject matter may be used with other oven appliance configurations, e.g., that define one or more interior cavities for the receipt of food and/or having different pan or rack arrangements than what is shown in FIG. 2. Further, the present subject matter may be used in a stand-alone cooktop, a hot plate, or any other suitable appliance.

Oven appliance 10 generally includes a cooking assembly. The cooking assembly may include one or more heating elements. For example, in some embodiments, the cooking assembly, and thus the oven appliance 10 includes an insulated cabinet 12 with an interior cooking chamber 14 defined by an interior surface 15 of cabinet 12. Cooking chamber 14 is configured for the receipt of one or more food items to be cooked. Oven appliance 10 includes a door 16 rotatably mounted to cabinet 12, e.g., with a hinge (not shown). A handle 18 is mounted to door 16 and assists a user with opening and closing door 16 in order to access cooking chamber 14. For example, a user can pull on handle 18 to open or close door 16 and access cooking chamber 14.

Oven appliance 10 can include a seal (not shown) between door 16 and cabinet 12 that assists with maintaining heat and cooking fumes within cooking chamber 14 when door 16 is closed as shown in FIG. 2. Multiple parallel glass panes 22 provide for viewing the contents of cooking chamber 14 when door 16 is closed and assist with insulating cooking chamber 14. A baking rack 24 is positioned in cooking chamber 14 for the receipt of food items or utensils containing food items. Baking rack 24 is slidably received onto embossed ribs or sliding rails 26 such that rack 24 may be conveniently moved into and out of cooking chamber 14 when door 16 is open.

A gas fueled or electric bottom heating element 40 (e.g., a gas burner or a bake gas burner) is positioned in cabinet 12, e.g., at a bottom portion 30 of cabinet 12. Bottom heating element 40 is used to heat cooking chamber 14 for both cooking and cleaning of oven appliance 10. The size and heat output of bottom heating element 40 can be selected based on the e.g., the size of oven appliance 10.

A top heating element 42 is also positioned in cooking chamber 14 of cabinet 12, e.g., at a top portion 32 of cabinet 12. Top heating element 42 is used to heat cooking chamber 14 for both cooking/broiling and cleaning of oven appliance 10. Like bottom heating element 40, the size and heat output of top heating element 42 can be selected based on the e.g., the size of oven appliance 10. In the exemplary embodiment shown in FIG. 2, top heating element 42 is shown as an electric resistance heating element. However, in alternative embodiments, a gas, microwave, halogen, or any other suitable heating element may be used instead of electric resistance heating element 42.

As shown in FIG. 2, in some embodiments, a cooling air flow passageway 28 can be provided within cabinet 12 between cooking chamber 14 and cooktop 100. For example, a portion of passageway 28 may be between cooking chamber 14 and cooktop 100 along a vertical direction V. Passageway 28 is shown schematically in the figures. As will be understood by one of skill in the art using the teachings disclosed herein, cooling air flow passageway 28 may have a variety of configurations other than as shown. Air flowing through passageway 28 can provide convective cooling.

Referring now to FIGS. 3 and 4, the oven appliance 10 additionally includes a cooktop 100. Cooktop 100 may be disposed on the cabinet 12 such that the total volume of cabinet 12 is generally divided between the cooking chamber 14 and cooktop 100. As shown, cooktop 100 may include a top panel 104. By way of example, top panel 104 may be constructed of glass, ceramics, enameled steel, and combinations thereof. Heating assemblies 106, e.g., electric heating elements, may be mounted, for example, below the top panel 104. While shown with four heating assemblies 106 in the exemplary embodiment of FIGS. 3 and 4 (as well as FIG. 1), cooktop appliance 100 may include any number of heating assemblies 106 in alternative exemplary embodiments. Heating assemblies 106 can also have various diameters. For example, each heating assembly of heating assemblies 106 can have a different diameter, the same diameter, or any suitable combination thereof. Each heating assembly may include one or more heating elements 108, such that in some exemplary embodiments, the cooktop 100 includes at least one heating element 108. Relays (not shown) can selectively activate the associated heating elements 108 as desired. Activation of a heating element 108 can cause electricity to be flowed to that heating element 108, which in turn can cause the heating element 108 to generate heat. This heat may be transferred through the top panel 104 to utensils positioned on the top panel 104. The operation of heating elements 108, such as through operation of relays, may be controlled by a processing device such as controller 50.

Still referring to FIGS. 1 through 3, oven appliance 10 may further include a user interface panel 120, which may be located as shown within convenient reach of a user of the oven appliance 10. User interface panel 120 is generally a component that allows a user to interact with the oven appliance 10 to, for example, turn various heating elements (such as heating elements 40, 42, 108) on and off, adjust the temperature of the heating elements, set built-in timers, etc. A user interface panel 120 may include a user-interface 122 and a graphical display 124, which may be separate from or integrated with the user-interface element 122. The user-interface element 122 may include analog control elements, e.g., knobs or dials, or more preferably the user interface control elements can be all digital control elements, for example, a touchscreen comprising a plurality of elements thereon, as illustrated in FIGS. 3 and 4. Various commands for a user to select through such touching may be displayed by touchscreen 122, and detection of the user selecting a specific command by touching a distinct location on the touchscreen 122 may be detected by the controller 50, which is in communication with the touchscreen 122, based on electrical signals from the touchscreen 122. Graphical display 124 may generally deliver certain information to the user, which may be based on user selections and interaction with the touchscreen 122, such as whether a particular heating element is activated and/or the level at which the heating element is set.

Heating elements 108 can retain heat for some time after deactivation. In some embodiments, one or more hot surface indicator lights 126 can be used to inform a user that the cooktop surface is still relatively hot even after deactivation. In some embodiments one or more indicator lights 126 can be provided on or near the user interface panel 120, as illustrated in FIG. 3. In embodiments where the indicator lights 126 are provided on the user interface panel 120, the indicator lights 126 may be provided separately from the graphical display 124 or as a part of the graphical display 124. In some embodiments, an indicator light 126 can be provided proximate to each heating assembly 106 or heating element 108, as illustrated in FIG. 4. In such embodiments, an equal number of indicator lights 126 as heating elements 108 may be provided. Alternatively, other suitable locations on appliance 10 may be utilized. In each of the various embodiments, every heating element 108 corresponds to an indicator light 126, and in some embodiments, a single indicator light 126 may correspond to multiple heating elements 108. For example, appliance 10 may include only a single indicator light 126 which may correspond to all heating elements 108, or appliance 10 may include two or more indicator each of which corresponds to at least one heating element. One such exemplary embodiment may include two indicator lights 126, e.g., one corresponding to a left side subset of heating elements 108 and the other corresponding to a right side subset of heating elements 108.

Oven appliance 10 may include a controller 50 which generally controls operation of the various components of the oven appliance 10. Controller 50 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 50 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. User interface panel 120 and other components of oven appliance 10 may be in communication with controller 50 via one or more signal lines or shared communication busses.

Notably, controller 50 may be in communication with the user interface 122, graphical display 124, indicator lights 126, and one or more heating elements. Accordingly, input signals received from the user interface 122 may be provided to and interpreted by the controller 50, and the controller 50 may output corresponding control signals to the heating elements to operate the heating elements as desired. Additionally, the controller 50 may include or be connected to one or more sensors or switches which transmit sensed values or discrete signals to the controller and the controller may output control signals to the indicator lights 126 to selectively illuminate or deactivate one or more of the indicator lights 126 based on the sensed values.

In some embodiments, such as the examples illustrated in FIGS. 1, 3, and 4, one or more resistance sensors 140 may be provided, which may be an equal number of resistance sensors 140 as heating elements 108. The sensors 140 may be positioned proximate the user interface 122, such as within the user interface panel 120. Resistance sensor 140 may alternatively be within the user interface panel 120 and distal from the user interface 122, or in any other suitable location. The resistance sensor(s) 140 may be in communication with the controller 50 and in some embodiments may be integrated with the controller 50, e.g., on a control board spaced from the heating element(s) 108, such as within user interface panel 120. A resistance sensor 140 is in communication with one or more heating elements 108 to measure the resistance of the heating elements 108. Resistance sensor 140 is also in communication with the indicator lights 126, directly in some embodiments, and/or via the controller 50 in additional embodiments, to transmit signals to the indicator lights 126 based on the sensed resistance of the heating elements 108.

In certain embodiments, heating elements 108 can be electrical resistance heating elements, for example as illustrated in FIGS. 3 and 4. In such embodiments, the resistance value of the electrical resistance heating elements 108 will change with temperature. As such, the use of resistance sensor(s) 140 enables indirect measurement of the temperature of the heating elements 108 which, as may be seen in, e.g., FIG. 1, can be performed remotely by a resistance sensor 140 located away from the heating element 108. By eliminating the need for direct temperature measurement, there is no sensor mounted to the heating element, i.e., there are no sensors onboard the heating elements. Since there are no sensors onboard the heating elements 108, additional space between the cooktop 100 and the cooking chamber 14 is available within the cabinet 12. This additional space can be used to provide several possible advantages. For example, an unobstructed air flow path 28 for convection cooling may be provided, i.e., air flow path 28 can be provided such that there are no sensors in the air flow path 28 between the cooktop 100 and the cooking chamber 14. As a further example, the oven chamber 14 can be larger in proportion to the overall size of the cabinet 12 as well as or instead of the air flow path 28.

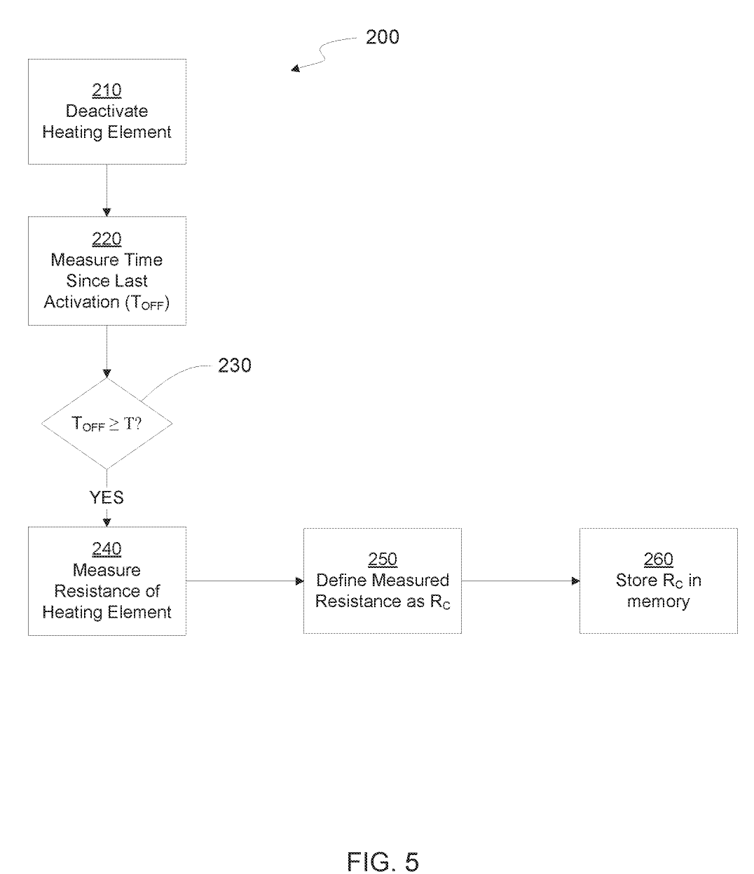

In some embodiments, the controller 50 can be configured to detect the operational status of each heating element 108, e.g., whether the heating element 108 is on or off. The controller 50 may also, in some embodiments, include a real-time clock or otherwise be configured to measure time. As illustrated, e.g., in FIG. 5, in one or more embodiments, a method 200 of operating a cooktop appliance 10 can include the controller configured to determine that a heating element 108 has been deactivated at step 210 and measure the time T_{OFF} since the heating element 108 was last activated at step 220. Further, in one or more embodiments, the controller 50 may be configured to perform step 230 of comparing the time since last activation, T_{OFF}, to a threshold time, T, which can be, for example about 120 minutes, about 150 minutes, about 180 minutes, or more, or less so long as the threshold time T is long enough for the heat from heating element 108 to substantially dissipate. Threshold time T may for example, be empirically determined for appliance 10. It is generally understood that the heat from heating element has substantially dissipated when the temperature of the heating element 108 and/or cooktop 100 is less than about 150° C. In such embodiments, when the time since last activation T_{OFF} is greater than or equal to threshold time T, it can be determined thereby that the heating element 108 is cool and the controller 50 and/or resistance sensor 140 may be configured to perform step 240 of measuring the resistance of the heating element 108 at that time and step 250 of defining the measured resistance as a cool resistance R_{C}, of the heating element 108. Further, some embodiments of the controller 50 may be configured to perform step 260 of storing the cool resistance R_{C} in a computer memory. Cool resistance R_{C} can also be measured when oven appliance 10 is manufactured or installed, i.e., before initial activation of heating element 108. Cool resistance R_{C} can, after being initially determined, remain as a programmed value or be continuously calibrated and updated after activations of heating element(s) 108.

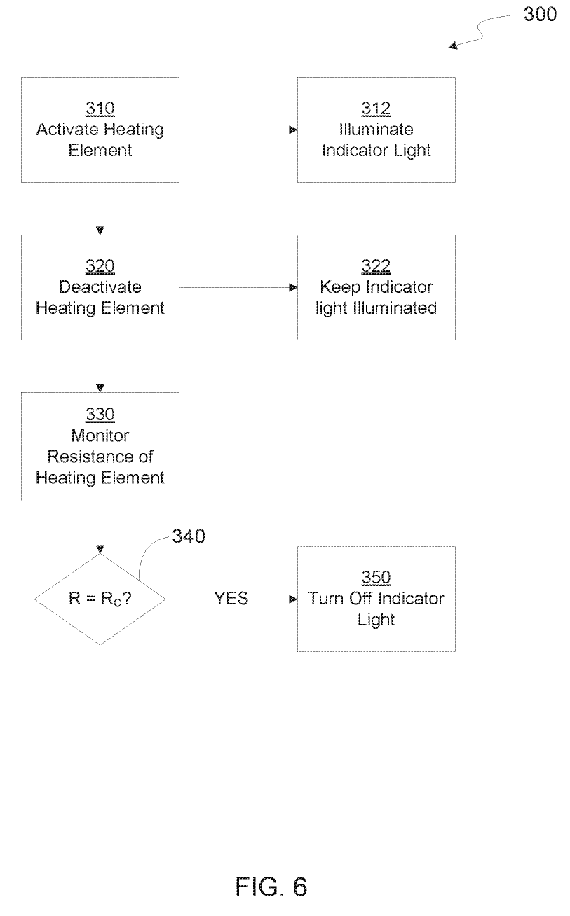

As illustrated for example in FIG. 6, a method 300 can include, when a heating element 108 is turned on at step 310, illuminating associated indicator light 126 at step 312. In some embodiments, the controller 50 may also be configured to send a signal to the indicator light 126 to activate the indicator light. Additionally or in the alternative, the indicator light 126 may in certain embodiments otherwise be configured to illuminate when the heating element 108 is activated such as by a direct connection between the heating element 108 and the indicator light 126. The indicator light 126 can also be configured to remain illuminated at step 322 after the heating element 108 is deactivated at step 320 and to remain illuminated until the temperature of cooktop surface 100 reaches a relatively cool temperature of about 150° C. or less, i.e., T_{OFF} exceeds T. The controller 50 can be configured to determine that the heating element 108 is cool based on the resistance of the heating element. When the heating element 108 is deactivated, the controller and/or resistance sensor 140 are configured to initiate a resistance monitoring step 330 that includes measuring the resistance of the heating element 108 over time, which measurement can be continuous or at selected time intervals. In some embodiments the resistance monitoring step may further include 340 comparing the measured resistance value, R, to the cool resistance value R_{C} and continuing to measure the resistance of heating element 108 until R equals R_{C}, at which point step 350 of deactivating the corresponding indicator light 126 may be performed. In some embodiments wherein more than one heating element 108 is provided, a plurality of heating elements 108 may be activated at the same time. In such embodiments, the resistance monitoring step may further include monitoring the resistance of a selected one of the plurality of heating elements 108 after all of the heating 108 elements are turned off, and to turn off the indicator light 126 when the resistance of the selected heating element 108 equals the cool resistance value, wherein the selected one of the plurality of heating elements 108 may be the last heating element 108 to be turned off.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance comprising:
a cabinet defining a cooking chamber, the cooking chamber configured for receipt of items to be cooked;
a cooktop disposed on the cabinet, the cooktop comprising at least one heating element;
an indicator light;
a resistance sensor spaced from the heating element; and
a controller in communication with the heating element, the resistance sensor, and the indicator light, the controller operable to store a cool resistance value of the heating element, to illuminate the indicator light when the heating element is turned on, to keep the indicator light illuminated after the heating element is turned off, to monitor a resistance of the heating element after it is turned off, and to turn off the indicator light when the resistance of the heating element equals the cool resistance value;
wherein there are no sensors onboard the heating element.

2. The oven appliance of claim 1, wherein the cooktop is spaced from the cooking chamber to define an air flow path between the cooktop and the cooking chamber.

3. The oven appliance of claim 2, wherein there are no sensors in the air flow path between the cooktop and the cooking chamber.

4. The oven appliance of claim 2, wherein the air flow path is unobstructed.

5. The oven appliance of claim 1, further comprising a control board spaced from the heating element, wherein the resistance sensor and the controller are located on the control board.

6. The oven appliance of claim 1, wherein the at least one heating element comprises a plurality of heating elements and the oven appliance further comprises an equal number of resistance sensors as heating elements, the controller in communication with each heating element and each resistance sensor, the controller operable to store a cool resistance value of each heating element, to illuminate the indicator light when one or more of the plurality of heating elements is turned on, to keep the indicator light illuminated after each heating element is turned off, to monitor the resistance of a selected one of the plurality of heating elements after all of the heating elements are turned off, and to turn off the indicator light when the resistance of the selected heating element equals the cool resistance value.

7. The oven appliance of claim 6, wherein the selected one of the plurality of heating elements is the last heating element to be turned off.

8. The oven appliance of claim 1, wherein the at least one heating element comprises a plurality of heating elements and the resistance sensor comprises a single resistance sensor multiplexed to the plurality of heating elements.

9. The oven appliance of claim 1, further comprising a plurality of indicator lights and an equal number of resistance sensors as heating elements, wherein the at least one heating element comprises a plurality of heating elements, the plurality of indicator lights comprises an equal number of indicator lights as heating elements and each indicator light corresponds to one of the plurality of heating elements, the controller in communication with each heating element, each resistance sensor, and each indicator light, the controller operable to store a cool resistance value of each heating element, to illuminate a corresponding indicator light when the corresponding heating element is turned on, to keep the indicator light illuminated after the corresponding heating element is turned off, to monitor the resistance of the corresponding heating element after the corresponding heating element is turned off, and to turn off the indicator light when the resistance of the corresponding heating element equals the cool resistance value.

10. The oven appliance of claim 1, further comprising a user interface panel and a plurality of user interface controls on the user interface panel.

11. The oven appliance of claim 10, wherein the user interface controls are all digital.

12. The oven appliance of claim 1, wherein the at least one heating element comprises a cooktop burner.

13. The oven appliance of claim 1, wherein the cooktop comprises a glass panel.

14. The oven appliance of claim 1, wherein the cooktop comprises a ceramic panel.

15. A method of operating a cooktop appliance, comprising:
activating a heating element;
illuminating an indicator light when the heating element is activated;
deactivating the heating element;
keeping the indicator light illuminated after the heating element is deactivated;
monitoring resistance of the heating element after the heating element is deactivated; and
turning off the indicator light when the resistance of the heating element equals a cool resistance value of the heating element.

16. The method of claim 15, further comprising determining that the heating element of the cooktop appliance is in a cool state, measuring the resistance of the heating element when it is in the cool state, and defining the measured resistance as the cool resistance value.

17. The method of claim 16, wherein the determining step comprises determining that the heating element has been deactivated, measuring the time since the heating element was last activated, and determining that the heating element is in a cool state when the time since the heating element was last activated is greater than a threshold time.

18. The method of claim 16, further comprising storing the defined cool resistance value in a computer memory.

19. The method of claim 15, wherein the monitoring step comprises measuring the resistance of the heating element in real time while comparing the real-time measured resistance to the cool resistance value.

20. The method of claim 15, wherein the measuring step and the monitoring step further comprise using a resistance sensor located remotely from the heating element.
